(19) United States
(12) Patent Application Publication
(10) Pub. No.: US 2017/0337922 A1
(43) Pub. Date: Nov. 23, 2017

(54) SYSTEM AND METHODS FOR MODIFYING USER PRONUNCIATION TO ACHIEVE BETTER RECOGNITION RESULTS

(71) Applicants: Julia Komissarchik, Draper, UT (US); Edward Komissarchik, Draper, UT (US)

(72) Inventors: Julia Komissarchik, Draper, UT (US); Edward Komissarchik, Draper, UT (US)

(21) Appl. No.: 15/587,234

(22) Filed: May 4, 2017

Related U.S. Application Data
(60) Provisional application No. 62/339,011, filed on May 19, 2016.

(51) Int. Cl. G10L 15/22

(52) U.S. Cl. CPC G10L 15/22; G10L 2015/225

(57) ABSTRACT

A system and method for analyzing the results of voice-based human-machine interaction to recommend adjustments in user speech to improve quality of recognition and usability of communication is provided.

### FIELD OF THE INVENTION

The present invention relates generally to the field of voice-based human-machine interaction and particularly to a system of adjustment of user's speech pattern to achieve better communication with electronic device.

### BACKGROUND OF THE INVENTION

Voice-based communication with an electronic device (computer, smartphone, car, home appliance) is becoming ubiquitous. Improvement in speech recognition is a major driver of this process. Over the last 10 years voice-based dialog with a machine changed from being a curiosity and most often a nuisance to a real tool. Personal assistants like Siri are now part of many people's daily routine. However, the interaction is still quite a frustrating experience for many. There are several reasons for that—insufficient quality of speech recognition engines, unconstrained nature of interactions (large vocabulary), ungrammatical utterances, regional accents, communication in non-native language. Over last 30 years a number of techniques was introduced to compensate insufficient quality of speech recognition by using on the one hand more restrained dialog/multiple choice model/smaller vocabulary/known discourse, and on the other hand adaptation of a speech engine to a particular speaker. The problem with the first group of remedies is that it is not always possible to reduce real life human machine interaction to obey these restrictions. The problem with the second approach (speaker adaptation) is that to provide meaningful improvement the speech engine requires a large number of sample utterance of a user, which means that the user should tolerate insufficient quality of recognition for a while. However, even if this adaptation is accomplished, it still does not address the problem of a conversational nature of the interaction that includes hesitation, repetition, parasitic words, ungrammatical sentences etc. Even such natural reaction as speaking deliberately with pauses between words when talking to somebody who does not understand what was said, throws speech recognition engine completely off. In spite of a lot of efforts made and continued to be made by companies developing speech recognition engines such as Google, Nuance, Apple, Microsoft, Amazon, Samsung and others to improve quality of speech recognition and efficiency of speaker adaptation, the problem is far from being solved.

The drawback of forcing speech recognition engine to try to recognize human speech even if a user has serious issues with correct pronunciation and even speech impediments is that it forces the machine to recognize something that is simply not there. This leads to either incorrect recognition of what user wanted to say (but did not) or inability to recognize the utterance at all.

In view of the shortcomings of the prior art, it would be desirable to develop a new approach that can detect what is wrong with user pronunciation and help a user to improve pronunciation and to offer alternative phrases that have similar meaning but are less challenging to pronounce for this particular user.

It further would be desirable to provide a system and methods for modifying pronunciation of a user to achieve better recognition results.

It still further would be desirable to provide a system and methods for modifying user pronunciation that monitors recognition results of publicly accessible third party ASR systems and provides automatic feedback to assist users to correct mispronunciation errors and to suggest alternative phrases with the same meaning that are less difficult for user to pronounce correctly.

### SUMMARY OF THE INVENTION

The present invention is a system and method for analyzing the results of voice-based human-machine interaction to recommend adjustments in user speech to improve quality of speech recognition and usability of the communication between a human and a machine.

In view of the aforementioned drawbacks of previously known systems and methods, the present invention provides a system and methods for detecting what is wrong with user pronunciation and helping the user to modify his or her pronunciation to achieve better recognition results.

This invention addresses the problem of voice-based human-machine interaction from a fresh direction. Instead of trying to bring a machine “closer” to humans, we propose how to help humans to bring themselves “closer” to a machine by making slight modifications in how and what they speak to a machine.

The approach of this invention is to analyze the results of speech recognition of one or many utterances and provide feedback to a user on how to improve recognition by changing user speech. That includes among others things focusing on correcting mispronunciation of certain phonemes, triphones and words and making changes in utterance flow.

The present invention further provides alternative phrases to ones that user cannot pronounce correctly that have same or similar meaning but are less challenging to pronounce for this particular user and that are recognized better by a machine.

In accordance with one aspect to the invention, a system and methods for improving speech recognition results are provided wherein the response of a publicly accessible third party ASR system to user utterances is monitored to detect mispronunciations and speech peculiarities of a user.

In accordance with another aspect of the invention the system and methods for automatic feedback are provided to assist users to correct mispronunciation errors and to suggest alternative phrases with the same or similar meaning that are less difficult for user to pronounce correctly that lead to better recognition results.

This invention can be used in multiple situations where a user talks to an electronic device. Areas such as Intelligent Assistant, Smartphones, Auto, Internet of Things, Call Centers, IVRs and voice-based CRMs are samples of applicability of this invention.

Though some examples in the Detailed Description of the Preferred Embodiments Invention and in the Drawings are referring to English language, the one skilled in the art will see that the methods of this invention are language independent and can be applied to any language and can be used in any voice-based human-machine interaction based on any speech recognition engine.

### BRIEF DESCRIPTION OF THE DRAWINGS

Further features of the invention, its nature and various advantages will be apparent from the accompanying drawings and the following detailed description of the preferred embodiments, in which:

FIGS. 1 and 2 are, respectively, a schematic diagram of the system of the present invention comprising software modules programmed to operate on a computer system of conventional design having Internet access, and representative components of exemplary hardware for implementing the system of FIG. 1.

FIG. 3 is a schematic diagram of aspects of an exemplary unsupervised analysis system suitable for use in the systems and methods of the present invention.

FIG. 4 is a schematic diagram depicting an exemplary supervised analysis system in accordance with the present invention.

FIG. 5 is a schematic diagram depicting an exemplary embodiment of a user feedback system in accordance with the present invention.

### DETAILED DESCRIPTION OF THE PREFERRED EMBODIMENTS

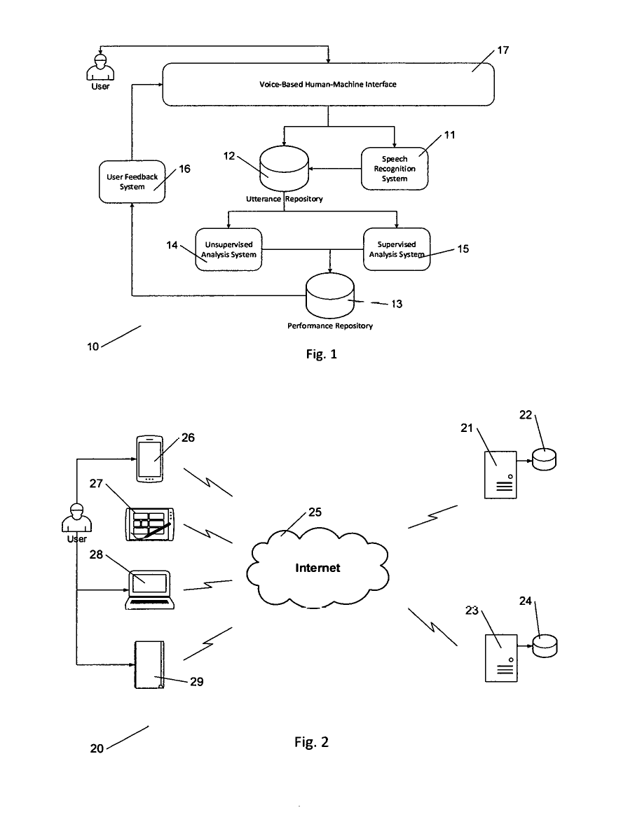

Referring to FIG. 1, system 10 for modifying user pronunciation for better recognition is described. System 10 comprises a number of software modules that cooperate to detect mispronunciations in a user's utterances, to detect systematic speech recognition errors caused by such mispronunciations or ASR deficiencies, and preferably provide detailed feedback to the user that enables him or her to achieve better speech recognition results. In particular, system 10 comprise automatic speech recognition system (“ASR”) 11, utterance repository 12, performance repository 13, unsupervised analysis system 14, supervised analysis system 15, user feedback system 16 and human-machine interface component 17.

Components 11-17 may be implemented as a standalone system capable of running on a single personal computer. More preferably, however, components 11-17 are distributed over a network, so that certain components, such as repositories 12, 13 and ASR 11 reside on servers accessible via the Internet. FIG. 2 provides one such exemplary embodiment of system 20, wherein repositories 12, 13 may be hosted by the provider of the pronunciation modification software on server cluster 21 including database 22, while ASR system 11, such as the Google Voice system, is hosted on server 23 including database 24. Servers 21 and 23 are coupled to Internet 25 via known communication pathways, including wired and wireless networks.

A user using the inventive system and methods of the present invention may access Internet 25 via mobile phone 26, via tablet 27, via personal computer 28, or via home appliance 29. Human-machine interface component 17 preferably is loaded onto and runs on mobile devices 26 or 27 or computer 28, while utterance repository 12, performance repository 13, unsupervised analysis system 14, supervised analysis system 15, user feedback system 16 may operate either on the client side (i.e., mobile devices 26 or 27 or computer 28) or server side (i.e., server 21), depending upon the complexity and processing capability required for specific embodiments of the inventive system.

Each of the foregoing subsystems and components 11-17 are described below.

Automatic Speech Recognition System (ASR)

The system can use any ASR. Though multiple ASRs can be used in parallel to process user's speech, a typical configuration consists of just one ASR. A number of companies (e.g.

Google, Nuance, Apple, Microsoft, Amazon and Samsung) have good ASRs that are used in different tasks spanning voice assistance, web search, navigation, voice commands. In a preferred embodiment, human-machine interface 17 may be coded to accept a speech sample from the microphone of mobile device 26 or mobile device 28 or computer 26 or household appliance 29, invoke, say, Google ASR via the Internet, and process the results returned from Google ASR as further described below. Most of ASRs have Application Program Interfaces (API) that provide details of the recognition process including alternative recognition results (so called N-Best list) and in some cases acoustic features of the utterances spoken. Recognition results provided through the API in many cases are associated with weights that show level of confidence that ASR has in each particular alternative. The N-Best list is especially important for the situations where it is not known what a user said or was supposed to say as described below in Unsupervised Analysis System.

Utterance Repository

To be able to provide a more balanced feedback to a user regarding intelligibility of his speech to a machine, a repository of user's utterances and ASR results is maintained. For each utterance stored in the repository, the following information can be stored:
Text that a user was supposed to utter (not empty for supervised communication scenario)
Recording of the utterance (if needed—usually stored locally to be included as illustration for feedback to a user but can also be stored in the cloud)
Acoustic features of the utterance
For each recognition alternative parameters such as confidence level, position in the N-Best list

Usually only utterances with at least one alternative with high confidence level are stored. The ones that have low confidence level even for the best recognition alternative typically are too garbled to be useful or meaningful for user feedback.

Performance Repository

Performance Repository contains historical and aggregated information of user pronunciation. Its purpose is to provide a user with a perspective of user's voice-based interaction with a machine and to store information about main aspects of user pronunciation to be modified to increase user's intelligibility to machine. The Performance Repository can contain the following information:
History/Time Series of recognition of individual phonemes, words and collocations
Comparative recognition results for difficult (for user) words/phrases to pronounce and their easier to pronounce synonyms
History/Time Series of speech disfluencies

Though the repository's main purpose is to help individual user improve voice-based communication with machine, a combined repository for multiple users can be used by designers of human-machine interface to improve the interface. For example, in case of voice-based dialog/command systems it might lead to changes in the vocabulary used in such a system.

Unsupervised Analysis System

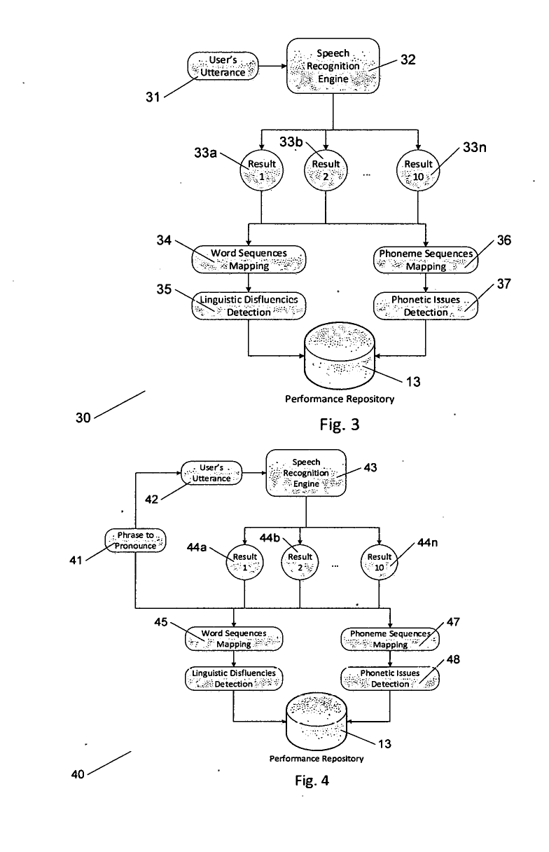

Referring now to FIG. 3, the unsupervised analysis system 30 deals with ASR results in cases when it is not known what phrase was pronounced or supposed to be pronounced by a user. This situation is typical, for example, for voice web search or voice interaction with a GPS system in a car. Some human-machine interfaces include a confirmation step where user confirms the results of recognition. If the confirmation step is present then the analysis becomes supervised as described below in Supervised Analysis System.

Referring again to FIG. 3, the Unsupervised Analysis System consists of Word Sequences Mapping 34, Linguistic Disfluency and Grammar Issues Detection 35, Phoneme Sequences Mapping 36 and Phonetic Issues Detection 37.

Word Sequence Mapping

Common intervals are word sequences (intervals) that are common for several possible recognized alternatives of ASR. These intervals are used as indicators of the parts of the utterance that were reliably recognized. What lays between these common intervals is the area where potential problems are. In some cases these problems indicate ASR weaknesses or errors, but also they can be a result of user mispronunciations and other user-generated problems in voice-based communication. Word Sequences Mapping Algorithm determines common intervals and the areas between; the output of the Word Sequence Mapping 34 is used in User Feedback System 16.

Word Sequences Mapping Algorithm takes all ASR alternative recognition results (phrases) for a particular utterance. Let P be a list of phrases. If the results have confidence score, assign to each phrase in P this score as phrase score. If confidence scores are not available, assign score according to the position in the list using some diminishing function. For example, it can be 1/p where p is a position in the list. This way the top result will have score 1, the second one will have the score 0.5, etc. Or it can be a linear function, where score for the top phrase can be 1 while each subsequent phrase in the n-best list will have 10% lower score than the previous one. Let N be a number of phrases in P. If N<2 there is nothing to compare, so no actions are needed. Maintain a list S of common word subsequences (intervals). The initial value is S=P [1]. Calculate the cutoff value M for the number of phrases to be used for the matching algorithm using the following process. Let M=N. Let T [1]=score (P [1]). For each 1<I<=N if T [I−1]>score (P [I])*C then M=I−1 and end loop; else T [I]=T [I−1]+score (P [I]) and continue. C is a predefined threshold. For example, if the top two phrases in P have scores close to 1 and the phrase P [3] has score less than 0.6 and C=3 then only first two phrases will be used for matching. If M=1 then no action is taken since there is nothing to compare.

Mapping Algorithm
1. Take top M phrases from N-best list
2. If M<2 go to End
3. For 1<I<=M
4. Build a bipartite graph with nodes being words in intervals from S [I−1] and P [I] and edges connecting equal words
5. Choose maximum sequential bipartite matching with no intersections
6. S [I] consists of (maximal by inclusion) intervals in P [I] belonging to the maximum matching in 5.
7. Loop
8. End

The intervals from S [M] constitute sequence of common word intervals for recognition results with high levels of confidence.

Linguistic Disfluency and Grammar Issues Detection

ASRs rely heavily on the linguistic side of speech. The more similar utterance is with the formal text the higher the recognition rate. The use of parasitic phrases like “like”, “you know”, hesitation like “er”, “ahem”, “um”, repetition of words and deviation from grammar can significantly decrease the ability of ASR to recognize what was said. One of the methods used by ASR is to use statistically more frequent sequences of two or three words in the row (bigrams, trigrams) as a booster for confidence level of recognition. As a result, a phrase that is more in line with a sequence of words that usually go together would be pushed higher in the N-Best list. For example, it is typical for an ASR to recognize a phrase “chocolate mouse” as “chocolate mousse” even if the word “mouse” was pronounced (and recorded) perfectly. The same is true for ASRs that use grammatical analysis and tend to push more grammatical results higher in the N-Best list.

It is easier to determine linguistic disfluencies in cases when one knows what was supposed to be said (supervised situation). However, even in an unsupervised situation it is possible to do so. For each common word interval, the system detects disfluencies like presence of parasitic phrases, locally ungrammatical phrases, word repetitions etc. Though, even if in the case of the currently analyzed utterance ASR apparently was able to recognize what was said (or at least consistently misrecognized it), presence of disfluencies and grammar irregularities demonstrate certain user habits that can be detrimental for voice-based communication. The detected issues are stored in Performance Repository 13.

The gaps between common intervals can be even more informational than common intervals themselves. These gaps show the parts of the utterance where ASR was not sure what exactly was said and had multiple possibilities. There are cases when the picture of possible word sequences filling the gap between consequent common intervals is so muddled that it is not possible to say with certainty what user did wrong or why the ASR was confused. However, quite often there are situations when there are just two possible word sequences in the gap. These situations indicate that certain phrases are not very well pronounced by a user or are confusing for ASR and thus better to be avoided. In this case use of different phrases with similar meaning can be a way out. It is especially true in cases of so-called minimum pairs where two words differ in one phoneme only and if mispronounced will make ASR task unsurmountable. For example, word pair like “bid-bit”, or “bat-vat” or “pit-peat” that differ in one phoneme. The information about confusing sequences is stored in the Performance Repository 13 to be used to provide feedback to a user with recommendations on how to avoid them.

Phoneme Sequence Mapping

Phoneme Sequence Mapping 36 uses the same algorithm as Word Sequence Mapping 34 but instead of sequences of words from ASR N-Best results, it deals with the sequences of phonemes from canonical pronunciation of these words. For example, a phoneme sequence to be used in mapping for a phrase “switch off the radio” in IPA nomenclature will be “swIt [symbol] redio”.

For Kanji-based languages such as Chinese a phonetical representation such as Pinyin can be used. For example, the phrase “switch off the radio” in Simplified Chinese will be [symbol] which in Pinyin will be “guānbì shōuyīnjī”.

The output of the Phoneme Sequence Mapping is used in User Feedback System 16.

Phonetic Issues Detection

Analogously to the detection of word level issues, phonetic issues can be determined using common phonetic intervals and gaps meshes between them. Common phonetic intervals are useful in determining what phonetic sequences user pronounced reliably. Certain combinations of phonemes can be difficult to produce even for native speakers. For example, many people use substitutions or transpositions to have easier time in speaking. Thus words like “etcetera” with a difficult sequence “ts” people pronounce “eksetera” because transition from “k” to “s” is easier to pronounce than transition from “t” to “s”. Similar situation is with the word “perspective” that many people pronounce “prospective” thus avoiding a cumbersome transition from retroflex “r” to “s” and then to another consonant. Presence of such difficult phonetic sequences in common phonetic intervals indicate that they are not difficult for a user, but their consistent absence indicates that they are. This information about phoneme pairs and triplets present in common phonetic intervals is stored in Performance Repository 13.

The mesh of phoneme sequences filling the gaps between common phonetic intervals provide a way to determine peculiarities and issues with user's pronunciation of individual sounds and their sequences. The comparison between different sequences in a gap is especially powerful in cases of gaps consisting of just one phoneme. This is the case of minimal pairs already discussed. Another important case is a multiple phoneme gap that shows transposition and substitutions especially in the case of consequent consonants. The information about minimal pairs (single phoneme substitution) as well as multiple phoneme substitutions and transpositions is stored in Performance Repository 13.

Supervised Analysis System

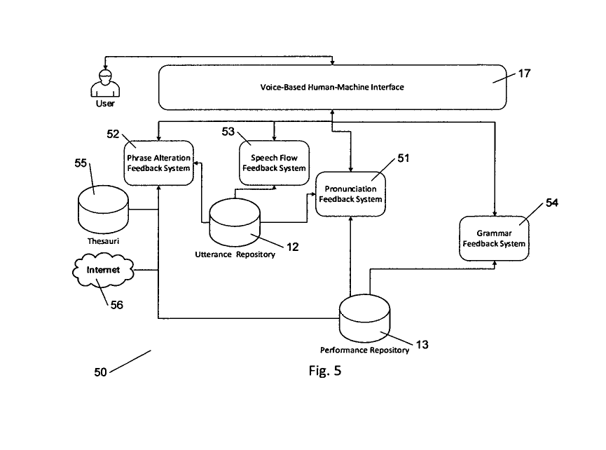

Referring now to FIG. 4, the supervised analysis system 40 deals with ASR results in cases when it is known what phrase was supposed to be pronounced by a user. This situation is typical for voice commands such as used in communication with a car or in communication with voice enabled home appliances. It is also the case in a dialog-based system when user is asked if what ASR recognized is correct and user confirms that it is or is not.

The mechanisms and concepts in a supervised situation are similar to unsupervised one as described above in Unsupervised Analysis System. However, supervised situation provides for more assertive error detection and follow-up feedback.

Referring again to FIG. 4, the Supervised Analysis System consists of Word Sequences Mapping 45, Linguistic Disfluency and Grammar Issues Detection 46, Phoneme Sequences Mapping 47 and Phonetic Issues Detection 48.

Word Sequence Mapping

The supervised situation allows building two sets of common intervals—one that represents what ASR provided in N-Best list and another one that compares recognition results with the “central” phrase that was supposed to be pronounced. The first one is done exactly as it is done in an unsupervised situation. The second set is built by applying the described above Word Sequences Mapping Algorithm first to the top two recognition results (sequence of words) and then the results to the “central” phrase.

Linguistic Disfluency and Grammar Issues Detection

For the mapping between ASR results the same methods of detection of linguistic/grammar issues are applied as in the unsupervised situation. This analysis provides an insight into the level of “stability”/“internal consistency” of ASR results. The second mapping (of the common intervals of the top two recognition results with the “central” phrase) provides visibility into transpositions, substitutions, hesitations and issues with grammar spanning the whole phrase as opposed to common intervals.

In cases when several top ASR results differ very little in their ASR confidence level it is useful to build unsupervised map between them and then map the result to the “central” phrase.

Phoneme Sequence Mapping

As in the case of word sequences, in the case of mapping in a supervised situation two sets of common intervals are built. The first set is built exactly as it is built in an unsupervised situation. The second set is built by mapping the phonetic representation of the top two recognition results and then mapping the results to the phonetic representation of the “central” phrase.

Phonetic Issues Detection

For the mapping between ASR results, the same methods for detection of phonetic issues are applied as in an unsupervised situation. This analysis provides an insight into the level of “certainty”/“confidence” of ASR phoneme level recognition. The second mapping (of the phonetic representation of the top recognition result to the phonetic representation of the “central” phrase) provides visibility into transpositions, substitutions, minimal pairs etc. spanning the whole utterance as opposed to common phonetic intervals.

In cases when several top ASR results differ very little in their ASR confidence level, it is useful to build an unsupervised mapping between them and then map the result to the “central” phrase.

User Feedback System

Referring to FIG. 5, the user Feedback System uses information stored in Utterance and Performance repositories to provide user with feedback on the ways to improve voice-based communication with machine and consists of Pronunciation Feedback System 51, Phrase Alteration Feedback System 52, Speech Flow Feedback System 53 and Grammar Feedback System 54.

Pronunciation Feedback System

Pronunciation Feedback System provides user with information about user's particular pronunciation habits and errors. The habits are more about specific regional accents and peculiarities of user's speech, while the errors are more about non-native speakers' difficulties in pronouncing phonemes and sequences of phonemes in the acquired language.

Performance Repository 13 is the main source of information as described above in Phonetic Issues Detection. For native speakers, typically, transpositions and poor articulation (garbled speech, “swallowing” of phonemes) constitute major issues. For non-native speakers it is often more about minimal pairs (e.g. confusion between “l” and “r” for Japanese speakers of English and confusion between “b” and “v” for Spanish speakers of English) and about certain phoneme sequences that contain parasitic sounds due to an unusual transitions (e.g. phoneme “r” in Slavic languages is a thrill sound, while in English it is a retroflex sound, so English speakers pronounced word “mir” as “miar” since transition from “i” to retroflex “r” is not possible without schwa).

Utterance Repository 12 is used to demonstrate how user pronounced words/phrases and what was recognized by ASR, so the user would be aware of what is happening “under the hood” and why pronunciation “adjustment” might be needed.

Phrase Alteration Feedback System

Performance Repository 13 provides an insight on words/phrases that, pronounced by a user, generate less than satisfactory recognition results. There are two major reasons for lower quality recognition of these words/phrases. The first one is related to the phonetics and the vocabulary of a language, while the second one is related to user's speech peculiarities and pronunciation errors.

Any language has clusters of words that are pronounced very similarly. The ultimate case of these clusters is presented by homophones—words that have exactly the same pronunciation (e.g. “you”, “ewe” and “yew”). When the words differ in just one phoneme then the clusters are called “minimal pair” (e.g. “bit” and “bid”). There are clusters that differ in more than one phoneme but due to the combination of the presence of unstressed vowels, poor articulation, transpositions and other factors, even native speakers' pronunciation of words from these clusters is confusing for human listeners let alone for ASR. For people with regional accents clusters can be wider or can be different. For non-native speakers the situation is exacerbated by user mispronouncing certain phonemes and phoneme sequences which makes these clusters of potentially confusing words even larger.

In some cases, it is really important from communication standpoint to use a particular word or phrase. However, in most cases it is OK to use a synonym or a word/phrase with similar meaning and still be able to communicate properly with a machine. For example, if a word “song” pronounced by a user is difficult for ASR to recognize, but the word “melody” pronounced by this user is recognized well, then it might be good enough to say “play a melody” instead of “play a song”.

The previous example covers the case when the user feedback system 50 knows a well-recognized alternative to poorly recognized word/phrase. If a good alternative for a poorly recognized word/phrase is known, it can be offered to a user. However, the chances that for each poorly recognized word/phrase there was a synonym or a word/phrase of similar meaning already pronounced by a user are not high. To deal with this more likely scenario, the system can offer an alternative based on overall proximity/synonymy in the language. So, even if the word “melody” was not yet pronounced by a user, this word can be offered as an alternative to the word “song”.

Typically, more than one choice of alternative in the language is available. Then the system can choose the one that is more likely to be well recognized by ASR based on the knowledge of user pronunciation habits and/or errors. For example, if a user cannot properly pronounce the burst “g” at the end of a word, and as a result the word “big” pronounced by user is poorly recognized, but user can pronounce the affricate “d₃”, then the system can suggest to use the word “large” instead. Similarly, if “1” sound is difficult for the user to pronounce, then the system can suggest using the word “huge” instead of “big”.

Internet represents a vast repository of texts, and can be used to find alternatives to be presented to a user. One of the methods to do that is based on statistical significance of co-occurrences of a phrase and alternative phrases in the same context.

The phrase alteration feedback system 52 can derive user feedback from the following data:
Graph of synonyms, hypernyms and hyponyms for words and collocations in a language derived from texts
Phonetic representation of words and collocations in the graph of synonyms, hypernyms and hyponyms
Instances of words/phrases pronounced by user that are stored in utterance repository 12
Time series from performance repository 13
Thesauri 55
Internet at large 56

For each statistically significant number of occurrences of poor recognition of a particular word/phrase by user in performance repository 13, the system chooses an alternative word/phrase for the pronounced word/phrase from the graph of synonyms, hypernyms and hyponyms (in that order) that has phonetic representation that is less prone to errors based upon time series from performance repository 13. Additionally, performance repository 13 is used to determine if, with time, a particular word/phrase or a particular phoneme/sequence of phonemes are no longer problematic and to avoid bothering user with feedback if a random mistake happened.

Speech Flow Feedback System

Speech flow issues are present in speech of practically every speaker. The tendency to hesitate, repetitions or use of parasitic words are normal occurrences in spontaneous speech. Moreover, users in many cases do not even realize that they do all these things. Speech flow feedback systems 53 identifies when these disfluencies happen, and use utterance repository 12 to playback what user said and show ASR results that were not satisfactory. Performance repository 13 helps not to overreact and not to bombard user with feedback if the time series show that user became better in some types of disfluencies.

Grammar Feedback System

Spontaneous speech is notoriously ungrammatical. However, on the local level in cases of noun phrases without sub clauses it is more likely to be in accordance to the rules of grammar. It is especially so if the issues with disfluencies are resolved to some extent. Grammar feedback system 54 goes hand in hand with speech flow feedback system 53. For non-native speakers, however, utterance become ungrammatical also because sequence of words in their native language and rules for government and binding can be very different from the ones in a second language. Therefore, if, for example, the verb at the end of a sentence that is typical for German happens in English speech, and the ASR results suffer from that, the system can specifically focus user's attention on this issue. The same is true for many other situation where wrong sequence of parts of speech leads to deterioration of ASR results even in case of perfect pronunciation. The latter is caused by the fact that ASR language model can supersede

What is claimed is:

1. A system for modifying pronunciation of a user to achieve better recognition results comprising:
a speech recognition system that analyzes an utterance spoken by the user and returns a ranked list of recognized phrases;
an unsupervised analysis module that analyzes the list of recognized phrases and determines the issues that led to less than desirable recognition results when it is not known what phrase a user was supposed to utter;
a supervised analysis module that analyzes the list of recognized phrases and determines the issues that led to less than desirable recognition results when it is known what phrase a user was supposed to utter;
a user feedback module that converts results of unsupervised or supervised analysis modules into instructions to the user on how to improve the results of speech recognition by changing pronunciation, speech flow and grammar of user's speech habits and which alternative phrases with similar meaning to use; and
a human-machine interface that communicates to user visually or aurally the recommendations of the user feedback module.

2. The system of claim 1 where users' utterances are stored in an utterance repository accessible via internet.

3. The system of claim 1, further comprising a performance repository accessible via the Internet, wherein users' mispronunciations and speech peculiarities are stored corresponding to their types.

4. The system of claim 1, further comprising an unsupervised speech analysis system that stores users' mispronunciations and speech peculiarities in a performance repository accessible via the Internet.

5. The system of claim 1, further comprising a supervised speech analysis system that stores users' mispronunciations and speech peculiarities in a performance repository accessible via the Internet.

6. The system of claim 1, wherein the speech recognition system is accessible via the Internet.

7. The system of claim 6, wherein the speech recognition system comprises a publicly available third-party speech recognition system.

8. The system of claim 1, further comprising a user feedback system that applies data analytics to the data stored in a performance repository to dynamically generate instructions to the user on how to improve the results of speech recognition by changing pronunciation, speech flow and grammar of user's speech habits and which alternative phrases with similar meaning.

10. The system of claim 1 wherein the human-machine interface is configured to operate on a mobile device.

11. A method for modifying pronunciation of a user to achieve better recognition results comprising:
analyzing user utterances in unsupervised and supervised settings using a speech recognition system, the speech recognition system returning a ranked list of recognized phrases;
using the ranked lists of recognition results to build user's pronunciation profile consisting of user's mispronunciations and speech peculiarities organized by types;
building guidance to the user on how to improve the results of speech recognition by changing pronunciation, speech flow and grammar of the user's speech habits and which alternative phrases with similar meaning to use; and
providing the guidance to the user visually or aurally.

12. The method of claim 11, further comprising accessing the speech recognition system via the Internet.

13. The method of claim 12, wherein accessing the speech recognition system via the Internet comprises accessing a publicly available third-party speech recognition system.

14. The method of claim 11, wherein the communication with the user is performed using a mobile device.
